(19) United States
(12) Patent Application Publication
(10) Pub. No.: US 2026/0009950 A1
(43) Pub. Date: Jan. 8, 2026

(54) MULTI-RING RESONATOR SHARED BUS STRUCTURES FOR OPTICAL COMMUNICATIONS

(71) Applicant: InfiniLink Inc., Wilmington, DE (US)

(72) Inventors: Diaa Abdelmaguid Mohamed Khalil, Cairo (EG); Salwa Ahmed Fouad Ahmed El-Sabban, Cairo (EG); Salah A. Ibrahim, Cairo (EG)

(73) Assignee: InfiniLink Inc., Wilmington, DE (US)

(21) Appl. No.: 19/259,355

(22) Filed: Jul. 3, 2025

Related U.S. Application Data
(60) Provisional application No. 63/668,242, filed on Jul. 7, 2024.

(51) Int. Cl. G02B 6/293; G02B 6/42

(52) U.S. Cl. CPC G02B 6/2934; G02B 6/29343; G02B 6/29383; G02B 6/29389; G02B 6/4266

(57) ABSTRACT

The techniques described herein relate to systems, apparatus, articles of manufacture, and methods for effectuating optical communications using an optical circuit. An example substrate includes a first ring resonator, a second ring resonator proximate to the first ring resonator and configured to control at least one optical property of the first ring resonator, and a waveguide bus disposed between the first ring resonator and the second ring resonator.

### RELATED APPLICATION

This application claims priority under 35 U.S.C. § 119 to U.S. Provisional Application No. 63/668,242, entitled “Double ring resonator shared bus structure,” filed on Jul. 7, 2024, which is herein incorporated by reference in its entirety.

### FIELD

The techniques described herein relate generally to optical circuits and, more particularly, to multi-ring resonator shared bus structures for optical communications.

### BACKGROUND

Data center networking demands are substantially increasing, driven by technologies such as fifth generation cellular (i.e., 5G), artificial intelligence and machine learning (AI/ML), cloud storage, Internet-of-Things (IoT), and video conferencing. Such technologies use high-bandwidth data links, which may include 100 gigabit/second (Gb/s) or greater capabilities over distances ranging from meters to kilometers.

Optical circuits, which transmit data via light, are well suited for these high-bandwidth requirements. A useful component in many optical circuits is the ring resonator. A ring resonator is a closed loop waveguide that can be used to facilitate light propagation in an optical circuit.

### SUMMARY

In accordance with the disclosed subject matter, apparatus, systems, and methods are provided for multi-ring resonator shared bus structures for optical communications.

Some embodiments relate to a substrate. The substrate comprises a first ring resonator, a second ring resonator proximate to the first ring resonator and configured to control at least one optical property of the first ring resonator, and a waveguide bus disposed between the first ring resonator and the second ring resonator.

Some embodiments relate to an optical circuit. The optical circuit comprises an input port configured to receive an optical signal, a substrate coupled to the input port and comprising: a first ring resonator, a second ring resonator proximate to the first ring resonator and configured to control at least one optical property of the first ring resonator, and a waveguide bus disposed between the first ring resonator and the second ring resonator. The optical circuit further comprises an actuator coupled to the second ring resonator, a sensor configured to measure a spectral response of the first ring resonator, a controller configured to control, using the spectral response, the actuator to change at least one of (i) a temperature of the second ring resonator and/or (ii) a voltage applied across the second ring resonator to cause a change in the at least one optical property of the first ring resonator, and an output port configured to output the optical signal.

Some embodiments relate to a method for adjusting at least one optical property associated with an optical circuit. The method comprises measuring, using at least one sensor, a spectral response of a first ring resonator disposed in proximity to a second ring resonator, determining, using a controller and the spectral response, an optical property of the first ring resonator, and adjusting, using the controller and the optical property, a temperature of the second ring resonator and/or a voltage applied across the second ring resonator to adjust the spectral response of the first ring resonator.

The foregoing summary is not intended to be limiting. Moreover, various aspects of the present disclosure may be implemented alone or in combination with other aspects.

### BRIEF DESCRIPTION OF FIGURES

Various aspects and embodiments of the present technology will be described with reference to the following figures. It should be appreciated that the figures are not necessarily drawn to scale. Items appearing in multiple figures are indicated by the same or a similar reference number in all the figures in which they appear.

FIG. 1A shows a top-down perspective view of an example multi-ring bus structure including multiple ring resonators and a waveguide, in accordance with some embodiments of the technology described herein.

FIG. 1B shows a cross section of the waveguide of the multi-ring bus structure of FIG. 1A, in accordance with some embodiments of the technology described herein.

FIG. 2 shows an example implementation of the multi-ring bus structure of FIG. 1A including an actuator, sensor, and controller, in accordance with some embodiments of the technology described herein.

FIG. 3A shows a top-down perspective view of an example semiconductor-based implementation of the multi-ring bus structure of FIGS. 1A and/or 2, in accordance with some embodiments of the technology described herein.

FIG. 3B shows a graph representing the light intensity output of the multi-ring bus structure of FIG. 3A plotted as a function of wavelength, in accordance with some embodiments of the technology described herein.

FIGS. 4A-C show top-down perspectives of respective example multi-ring bus structures each including multiple elliptical ring resonators and at least one waveguide, in accordance with some embodiments of the technology described herein.

FIG. 5 shows a perspective view of an example co-planar multi-ring bus structure including two ring resonators and a waveguide, in accordance with some embodiments of the technology described herein.

FIG. 6 shows a perspective view of an example vertically coupled multi-ring bus structure including two ring resonators and a waveguide, in accordance with some embodiments of the technology described herein.

FIG. 7 shows a top-down perspective view of an example multi-ring bus structure including four ring resonators and at least two waveguides, wherein at least two ring resonators are optically coupled to each other, in accordance with some embodiments of the technology described herein.

FIG. 8 shows graphs representing the normalized power at output ports of the multi-ring bus structure of FIG. 1A with the ring resonators of the multi-ring bus structure having the same refractive index, in accordance with some embodiments of the technology described herein.

FIG. 9 shows graphs representing the normalized power output of the multi-ring bus structure of FIG. 1A having a first refractive index caused by a temperature difference between the two ring resonators, in accordance with some embodiments of the technology described herein.

FIG. 10 shows graphs representing the normalized power output of the multi-ring bus structure of FIG. 1A having a second refractive index caused by a temperature difference between the two ring resonators, in accordance with some embodiments of the technology described herein.

FIG. 11 shows a graph representing the normalized power output of a second drop port in the multi-ring bus structure of FIG. 1A with respect to changes in a refractive index of the first ring of the multi-ring bus structure, in accordance with some embodiments of the technology described herein.

FIG. 12A shows a top-down perspective view of an example multi-ring bus structure, in accordance with some embodiments of the technology described herein.

FIG. 12B shows a graph representing transfer functions for different Q-factors of the first ring resonator in the multi-ring bus structure of FIG. 12A, in accordance with some embodiments of the technology described herein.

FIG. 12C shows a plot representing changes in the quality factor of the first ring resonator in the multi-ring bus structure of FIG. 12A with respect to changes in the roundtrip loss of the second ring resonator, in accordance with some embodiments of the technology described herein.

FIG. 13A shows an example all-pass ring resonator.

FIG. 13B shows an example add-drop ring resonator.

FIG. 13C shows an example two-ring resonator.

FIG. 14A shows an example opto-mechanical ring resonator.

FIG. 14B shows example deformation of the free-hanging arcs of FIG. 14A during operation.

FIG. 15 is a flowchart representative of an example process that may be performed and/or implemented using (i) hardware logic or (ii) machine-readable instructions that may be executed by processor circuitry to change at least one property of the first ring resonator of FIG. 1A using the second ring resonator of FIG. 1A that is in proximity to the first ring resonator, in accordance with some embodiments of the technology described herein.

### DETAILED DESCRIPTION

The present disclosure generally provides techniques for effectuating optical communications using an optical circuit that includes a multi-ring resonator shared bus structure. The multi-ring resonator shared bus structure is a structure that includes multiple ring resonators that share an optical bus (e.g., a shared optical bus). The multi-ring resonator shared bus structure can be included in an optical circuit, an optical transmitter, an optical receiver, and/or, more generally, an optical transceiver.

The multiple ring resonators can include at least first and second ring resonators coupled to the shared optical bus but may be optically uncoupled from each other. For example, the first ring resonator can be optically coupled to the shared optical bus but not optically coupled to the second ring resonator. The multi-ring bus structure can optimize and/or otherwise improve the transmission of optical signal through the shared optical bus by changing (e.g., dynamically changing) the coupling between the first ring resonator and the shared optical bus.

By way of example, the second ring resonator can change the first ring resonator's coupling to the shared optical bus by applying a temperature and/or voltage change across the second ring resonator. For example, changing a property of the second ring resonator can invoke and/or cause a corresponding change in a property of the first ring resonator. Beneficially, changing the coupling between the first ring resonator and the shared optical bus resultingly changes a quality factor, a spectral range, and/or a spectral response of the first ring resonator. Beneficially, controlling the quality factor, the spectral range, and/or the spectral response of the first ring resonator improves the overall performance of the optical circuit.

A typical optical circuit includes an optical resonator to amplify or store light. One type of optical resonator is a ring resonator. The ring resonator is implemented by an optical waveguide, a structure that confines and directs light, looped back onto itself. Owing to its geometry, the ring shape of the ring resonator enables it to function as an optical filter, multiplexer/de-multiplexer, and modulator, allowing for control over light propagation in optical circuits. The dimensions of the ring resonator (e.g., radius, thickness) influence the light wavelengths the ring resonator filters and amplifies, enabling it to also function as a light sensor. The ring resonator is frequently coupled to an optical bus. The optical bus can be implemented by a waveguide bus that internally propagates signals in the form of light. The waveguide bus can be a linear waveguide having an input port and output port through which light-based signals move.

There are multiple types of conventional ring resonators. A first conventional ring resonator is an all-pass ring resonator. An all-pass ring resonator is a single ring resonator coupled to a single waveguide bus.

A second conventional ring resonator is an add-drop ring resonator. An add-drop ring resonator is a single ring resonator coupled between a first waveguide bus and a second waveguide bus. In this arrangement, the first waveguide bus and the second waveguide bus are on opposing sides of the single ring resonator.

A third conventional ring resonator is a modified add-drop ring resonator. The modified add-drop ring resonator includes two ring resonators, a first waveguide bus, and a second waveguide bus. The two ring resonators are between the waveguide buses. The two ring resonators are coupled to each other. Each of the ring resonators is coupled to a respective one of the waveguide buses, but not both. For example, the two ring resonators are next to each other at the interior of the resonator structure, with the first waveguide bus on one side of the first ring resonator and the second waveguide bus on one side of the second ring resonator. The first ring resonator is coupled to the first waveguide bus, but not the second waveguide bus. The second ring resonator is coupled to the second waveguide bus, but not the first waveguide bus. The performance of this configuration relies on the ring resonators being coupled with each other, as the resonant wavelength moves with respect to the tuning of the individual rings.

A fourth conventional ring resonator includes a waveguide bus coupled to two ring resonators, whose arcs hang freely over a recession in a silicon chip. In this configuration, the waveguide bus provides optical forces to deflect the arcs of both rings. This configuration is described as an opto-mechanical ring resonator, referring to the mechanical deformation of the ring resonators' arcs during operation.

The inventors have recognized a technological challenge with such conventional ring resonators. The recognized technological challenge is that these ring resonators are highly sensitive to fabrication parameters and/or, more generally, process variation. Performance of ring resonators can be adversely affected even from relatively minor deviations in one or more fabrication parameters. Performance further degrades when two or more ring resonators are used as each ring resonator can be adversely affected from their own process variation. Examples of fabrication parameters include surface roughness, optical absorption, and material imperfection. Variations in one of these fabrication parameters or combination(s) thereof affect the quality factor of the ring resonator and its free spectral range.

The inventors developed technology to overcome the aforementioned technical challenge. The technology developed by the inventors involves an optical circuit that includes an optical waveguide bus and at least a first ring resonator and a second ring resonator. The ring resonators are not optically coupled to each other but share the same waveguide bus. The optical circuit includes a controller that can change an effective refractive index of the second ring resonator by causing a temperature and/or voltage change to be applied to the second ring resonator. The controller changing the effective refractive index of the second ring resonator alters the coupling coefficient between the first ring resonator and the waveguide bus and, correspondingly, changes the quality factor of the first ring resonator.

The technology developed by the inventors overcomes the technological challenge of ring resonators having high sensitivity to fabrication parameters by controlling the quality factor of a ring resonator using a different ring resonator to compensate for the undesirable variations in the device fabrication process. For example, if a first ring resonator is fabricated with a lower than expected quality factor due to a variation in the device fabrication process, the controller can change the effective refractive index of the second ring resonator to adjust the first ring resonator's quality factor to the desired quality factor. Beneficially, such controllability enables correction and/or mitigation of adverse effects from process variation, which can improve fabrication yield.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

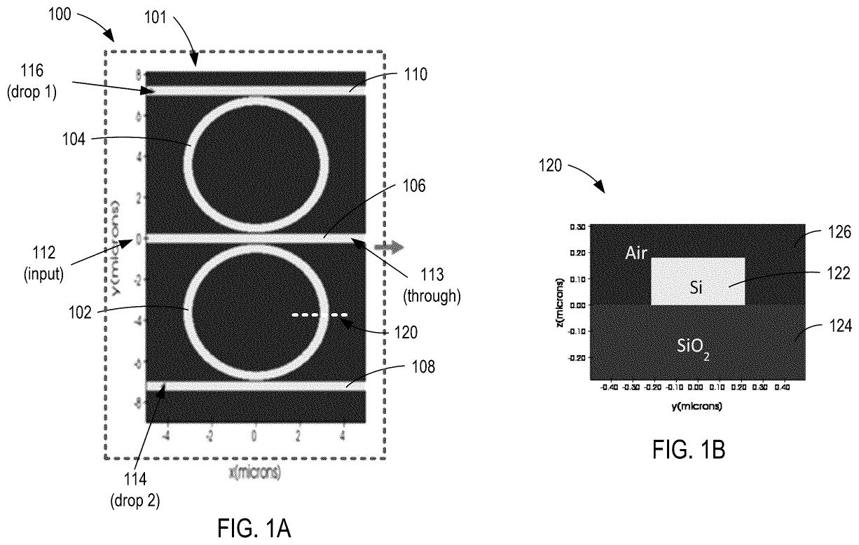

Turning to the figures, the illustrated example of FIG. 1A shows a top-down perspective view of an example optical circuit 100 including a multi-ring bus structure 101. In some embodiments, the optical circuit 100 implements at least part of an optical transmitter, an optical receiver, and/or optical transceiver. For example, an optical transceiver can implement and/or include the optical circuit 100.

As shown, the multi-ring bus structure 101 includes a first ring resonator 102, a second ring resonator 104, and a waveguide bus 106. The first and second ring resonators 102, 104 are ring resonators because they are circular in shape (e.g., ring shaped).

The first ring resonator 102 is in proximity to, but separated (e.g., physically separated) from, the second ring resonator 104. As shown, the first ring resonator 102 is separated from the second ring resonator 104 by the waveguide bus 106. The first ring resonator 102 and the second ring resonator 104 are each optically coupled to the waveguide bus 106, but not to each other. For example, the propagating light in the waveguide bus 106 is coupled (e.g., optically coupled) into each of the ring resonators 102, 104. In such an example, the propagating light in the first ring resonator 102 is not optically coupled into the second ring resonator 104 and vice versa.

The first ring resonator 102 can be configured as an optical filter for a range of wavelengths by dropping a signal that the first ring resonator 102 is in resonance with. Furthering the example, the second ring resonator 104 can be configured to resonate at the same range of wavelengths as the first ring resonator 102 to improve the filtering effect. The waveguide bus 106 can be configured to carry an optical signal (e.g., light) to be filtered by the first and second ring resonators 102, 104.

The multi-ring bus structure 101 includes multiple waveguides 108, 110. The multiple waveguides 108, 110 include at least a first waveguide 108 and a second waveguide 110. As shown, the first ring resonator 102 is coupled to the first waveguide 108, which is on a first side of the waveguide bus 106. As shown, the second ring resonator 104 is coupled to the second waveguide 110, which is on a second side of the waveguide bus 106. The first and second sides of the waveguide bus 106 are opposite each other.

In example operation, an optical signal is transmitted (e.g., propagated) through the waveguide bus 106. The optical signal enters the waveguide bus 106 through an input port 112 and exits through a through port 113 (e.g., an output port).

In some embodiments, the first waveguide 108 and the second waveguide 110 implement add/drop functionality. For example, the first waveguide 108 can be configured to inject light of a specific wavelength into the first ring resonator 102. In such an example, light can exit the first waveguide 108 through a drop port 114 (identified by “DROP 2”). Furthering the example, the second waveguide 110 can be configured to inject light of the same wavelength of the first waveguide 108 or a different specific wavelength into the second ring resonator 104. In such an example, light can exit the second waveguide 110 through a drop port 116 (identified by “DROP 1”).

The first ring resonator 102 is coupled to the first waveguide 108 through optical coupling. Coupling refers to the transfer of signals from one electrical component to another, often through the transfer of electrical energy. In optical circuits, optical coupling refers to the transfer of light from one optical component to another.

By way of example, the first ring resonator 102 can be optically coupled to the first waveguide 108 when the light waves in the first waveguide 108 transfer into the first ring resonator 102 and/or the light waves in the first ring resonator 102 transfer into the first waveguide 108. Furthering the example, the second ring resonator 104 can be optically coupled to the second waveguide 110 when the light waves in the second waveguide 110 transfer into the second ring resonator 104 and/or the light waves in the second ring resonator 104 transfer into the second waveguide 110.

In some embodiments, a first edge of the waveguide bus 106 on the first side of the waveguide bus 106 is separated from the first ring resonator 102 by a first distance (e.g., a first gap) of 0.1 micrometers (μm). For example, the first ring resonator 102 can be in proximity to the waveguide bus 106 by the first distance. Alternatively, the first distance may be shorter (e.g., 0.05 μm) or longer (e.g., 0.15 μm, 0.2 μm, etc.).

In some embodiments, a second edge of the waveguide bus 106 on the second side of the waveguide bus 106 is separated from the second ring resonator 104 by a second distance (e.g., a second gap) of 0.1 μm. For example, the second ring resonator 104 can be in proximity to the waveguide bus 106 by the second distance. Alternatively, the second distance may be shorter (e.g., 0.05 μm) or longer (e.g., 0.15 μm, 0.2 μm, etc.).

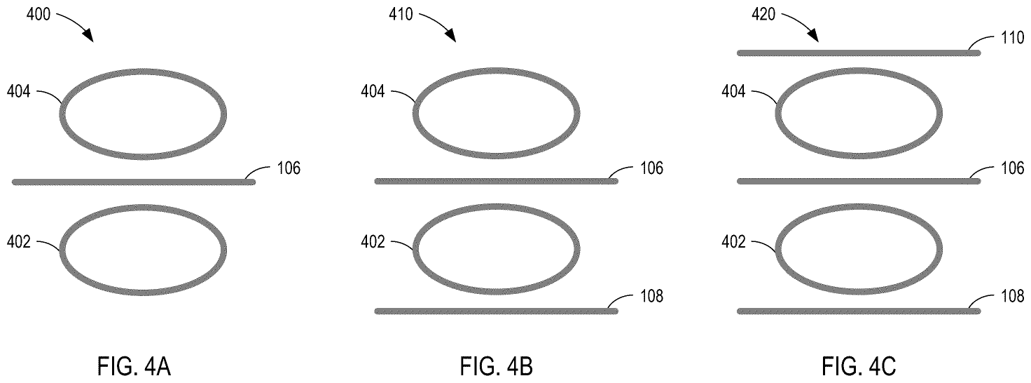

Although the ring resonators 102, 104 have a ring shape, the first ring resonator 102 and/or the second ring resonator 104 may have a different shape. An example shape is an elliptical shape. For example, the first ring resonator 102 and/or the second ring resonator 104 may be an elliptical resonator having an elliptical shape, as illustrated in the examples of FIGS. 4A-4C discussed further below.

In some embodiments, a change in at least one second property of the second ring resonator 104 causes a change in at least one first property of the first ring resonator 102. In some embodiments, the at least one first property can be an optical property. Examples of the at least one first property include an effective refractive index, a quality factor (Q-factor), a coupling strength, an optical absorption, a spectral range, and a spectral response. In some embodiments, at least one sensor as disclosed herein can be used to measure and/or sense an effective refractive index, a quality factor (Q-factor), a coupling strength, a spectral range, and a spectral response of the first ring resonator 102 and/or, more generally, the optical circuit 100.

In some embodiments, the coupling strength associated with the first ring resonator 102 can be between the first ring resonator 102 and the waveguide bus 106. In some embodiments, the spectral response is a free spectral range and refers to the frequency spacing between adjacent resonance modes within the first ring resonator 102.

Examples of the spectral response include at least one of a first value indicative of a power distribution, a second value indicative of a wave function, a third value indicative of an intensity spectrum, a fourth value indicative of a phase shift, a fifth value indicative of a mode number, or a sixth value indicative of an output optical power associated with the first ring resonator 102.

In some embodiments, the at least one second property is an electrical and/or thermal property. Examples of the at least one second property include a temperature and a voltage.

By way of example, the second ring resonator 104 can be configured to change a first property of the first ring resonator 102 in response to a temperature and/or voltage change to the second ring resonator 104. For example, a change in the temperature and/or voltage associated with the second ring resonator 104 can change at least one of the effective refractive index, the Q-factor, the coupling strength, the spectral response, and/or the spectral range of the first ring resonator 102 and/or, more generally, the multi-ring bus structure 101.

FIG. 1B shows a cross-section view of an example implementation of a substrate 120 including a waveguide 122, a first layer 124, and an upper cladding 126. The cross-section view is defined by a y-axis in microns and a z-axis in microns. In some embodiments, the waveguide 122 and/or, more generally, the substrate 120, can correspond to and/or implement the waveguide bus 106 of FIG. 1A.

In some embodiments, the substrate 120 is a glass substrate. Examples of the glass substrate include silicon, indium phosphide (InP), and silicon dioxide (SiO₂). As shown, the substrate 120 is a SiO₂ substrate.

In some embodiments, the waveguide 122 is disposed on the first layer 124 with the upper cladding 126. As shown, in FIG. 1B, the waveguide 122 is fabricated using silicon (Si). Alternatively, the waveguide 122 may be fabricated using at least one of silicon, gallium arsenide (GaAs), gallium nitride (GaN), gallium oxide (Ga₂O₂), silicon nitride (SiN), or lithium niobate (LiNbO₃).

As shown, the first layer 124 is fabricated on a SiO₂ layer. Alternatively, the first layer 124 may be fabricated using silicon, gallium arsenide, indium phosphide (InP), or gallium nitride.

In some embodiments, the waveguide 122 has a height of 180 nanometers (nm). Alternatively, the waveguide 122 may have a different height (e.g., 150 nm, 160 nm, 170 nm, 190 nm, etc.) or a height in a height range. For example, the waveguide 122 can have a height in a range of 100-200 nm.

In some embodiments, the waveguide 122 has a width of 400 nm. Alternatively, the waveguide 122 may have a different width (e.g., 370 nm, 380 nm, 390 nm, 410 nm, etc.) or a width in a width range. For example, the waveguide 122 can have a width in a range of 350-450 nm.

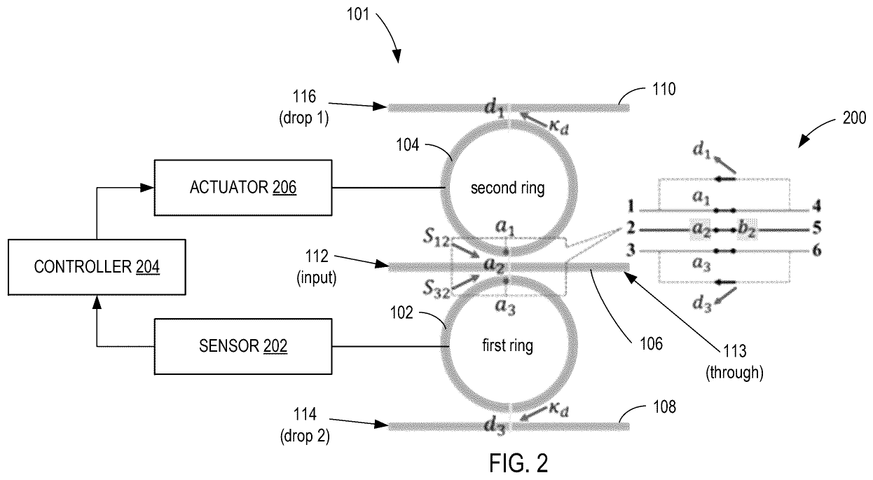

FIG. 2 shows an example implementation of the multi-ring bus structure 101 of FIG. 1A with example numerical variables labeled. As shown in FIG. 2, a sensor 202 is connected to and/or is in proximity (e.g., sensing proximity) to the first ring resonator 102. The sensor 202 can be configured to measure the first property of the first ring resonator 102. In some embodiments, the sensor 202 can be configured to measure the first property of the first ring resonator 102 through measurements at the through port 113 and the first drop port 114, such as output power, measurements, for example. Examples of the sensor 202 include a light sensor, a spectral sensor, and a spectrometer. Examples of the light sensor include a photodetector, a phototransistor, and a photodiode.

As shown, a controller 204 is coupled to the sensor 202. For example, the controller 204 can be configured to obtain and/or receive data (e.g., sensor measurements) from the sensor 202. The controller 204 can be configured to use measurements from the sensor 202 to determine whether or not to cause a change in the second property of the second ring resonator 104 to cause a corresponding change in the first property of the first ring resonator 102.

In response to determining that a change is to be made, the controller 204 can control an actuator 206 to change the second property of the second ring resonator 104. As shown, the controller 204 is coupled to the actuator 206. For example, the controller 204 can output a signal (e.g., a control signal) to enable or disable the actuator 206. Examples of the actuator 206 include thermal actuators, heating devices, electric actuators, magnetic actuators, pressure actuators, mechanical actuators, and semiconductor actuators (e.g., PN junctions).

In some embodiments, the controller 204 is implemented by at least one programmable processor. Examples of a programmable processor include a central processing unit (CPU), a digital signal processor (DSP), a field programmable gate array (FPGA), and a microcontroller. For example, the controller 204 can be implemented by at least one microcontroller configured to execute machine-readable instructions. Alternatively, the controller 204 may be implemented by at least one application specific integrated circuit (ASIC).

As shown in FIG. 2, the multi-ring bus structure 101 is labeled with a number of variables that can be used for the modeling of signaling through the geometry. Generally, aₘ is an amplitude of the modal field in a guide m, kₘₙ=kₙₘ is a coupling coefficient between a guide n and the guide m, where all the individual waveguides are assumed to be single mode waveguides, and dᵢ is the distance between two waveguides. For example, a₂ is the amplitude of a modal field in the waveguide bus 106. The field propagation through the multi-ring bus structure 101 can be described by the matrix equation in Equation (1) below:

$$i \frac{d}{dz} [ \begin{matrix}{a}_{1} \\ {a}_{2} \\ {a}_{3}\end{matrix} ] = [ \begin{matrix}0 & {k}_{12} & {k}_{13} \\ {k}_{21} & 0 & {k}_{23} \\ {k}_{31} & {k}_{32} & 0\end{matrix} ] [ \begin{matrix}{a}_{1} \\ {a}_{2} \\ {a}_{3}\end{matrix} ] , \qquad Equation ( 1 )$$

where i is an imaginary number. The power redistribution between the two outputs of the multi-ring bus structure 101 can be expressed by the amplitude of the modal field in each waveguide, such that, in Equations (2)-(4) below:

$${a}_{1} ( z ) = - i \frac{1}{\sqrt{1 + {ρ}^{2}}} sin ( {k}_{ef} z ) , \qquad Equation ( 2 )$$

$${a}_{2} ( z ) = cos ( {k}_{ef} z ) , \qquad Equation ( 3 )$$

$${a}_{3} ( z ) = - i \frac{ρ}{\sqrt{1 + {ρ}^{2}}} sin ( {k}_{ef} z ) , \qquad Equation ( 4 )$$

where k_{ef} is the effective coupling coefficient and ρ is the ratio between the two coupling coefficients of the waveguide bus 106 and the first and second ring resonators 102, 104. Equations (2)-(4) above illustrate that the behavior of the modal fields in the first and second ring resonators 102, 104 and the multi-ring bus structure 101 are all governed by k_{ef}.

The coupling coefficient between two waveguides is governed by the effective refractive index of each waveguide and the separation between the two waveguides. This is illustrated by an expression shown in Equation (5) below for the coupling coefficient between the second ring resonator 104 and the waveguide bus 106:

$${k}_{12} = \frac{ω {ε}_{O} \int {\int }_{- ∞}^{+ ∞} ( {N}^{2} - {N}_{2}^{2} ) {E}_{1}^{*} \cdot {E}_{2} dxdy}{\int {\int }_{- ∞}^{+ ∞} {a}_{z} \cdot ( {E}_{1}^{*} \times {H}_{1} + {E}_{1} \times {H}_{1}^{*} ) dxdy} , \qquad Equation ( 5 )$$

where, Eᵢ and Hᵢ are the electric and magnetic field distributions in waveguide i, N is a refractive index distribution in the multi-ring bus structure 101, and N₂ is a refractive index distribution of the waveguide bus 106, ω is the angular frequency, ε₀ is free space permittivity, and a_{z} is a unit vector in the direction of propagation of the optical wave. Equation (5) above illustrates that the coupling coefficient is influenced by the refractive index distribution of the waveguides, namely the refractive index of the second ring resonator 104. Further, a distance between the second ring resonator 104 and the waveguide bus 106 influences the coupling strength between them, k₁₂.

The relationship between the distance between the ring resonators 102, 104 and the waveguide bus 106 can be represented by an effective reduced length for the coupler where the effective length L_{ef} depends on the attenuation of the optical field outside the waveguide in the direction of the ring. FIG. 2 shows the multi-ring bus structure 101 from FIG. 1A further labeled to include the modal wave amplitudes (aₙ), a distance between two waveguides (dₙ), the coupling coefficients (kₙₘ), and amplitude coupling coefficients (Sₙₘ). For example, parameters of second drop port 116 are represented by Equations (6)-(8) below:

$${S}_{24} = \frac{- i}{1 + {ρ}^{2}} sin ( {k}_{ef} {L}_{ef} ) , \qquad Equation ( 6 )$$

$${S}_{25} = cos ( {k}_{ef} {L}_{ef} ) , \qquad Equation ( 7 )$$

$${S}_{26} = \frac{- i ρ}{\sqrt{1 + {ρ}^{2}}} sin ( {k}_{ef} {L}_{ef} ) , \qquad Equation ( 8 )$$

where ρ=k₂₃/k₂₁ is the ratio between the two coupling coefficients of the central guide with the first and second waveguides 102, 104, respectively. For example, d₃ is the distance between the first waveguide 108 and the first ring resonator 102 where ka is the effective coupling coefficient of the multi-ring bus structure 101.

Shown in FIG. 2, a₃ a modal wave amplitude of first ring resonator 102 and a₂ is a modal wave amplitude of the waveguide bus 106, The coupling between a₂ and a₃ is described by a coupling coefficient S₃₂. A dashed box 200 in FIG. 2 shows a zoomed view of the coupling between the first and second waveguides 102,104 and the waveguide bus 106. This box shows a detailed view of the coupling between the first ring resonator 102 (shown by a 1 to 6 waveguide path) and the waveguide bus 106 (shown by a 2 to 6 waveguide path).

Further performance defining parameters of the ring resonators 102, 104 are a roundtrip loss α_{Li} and a roundtrip phase ϕ_{Li} for a ring i. Round trip loss quantifies how much energy during the transmission of light through each complete trip around the ring resonator. Round trip phase describes the phase shift of a light wave after a complete trip around the ring resonator. The performance defining parameters are is related by a function Fᵢ. In the case of second ring resonator 102 and first ring resonator 104, respectively, the functions are equal to, as shown in Equations (9a) and (9b) below:

$${F}_{1} = \frac{{e}^{j {ϕ}_{L 1}}}{{α}_{L 1}} - {S}_{14} , \qquad Equation ( 9 a )$$

$${F}_{2} = \frac{{e}^{j {ϕ}_{L 2}}}{{α}_{L 2}} - {S}_{36} , \qquad Equation ( 9 b )$$

For the first and second ring resonators 102, 104 a first and second round trip field, a₃ and a₁, respectively, are represented in Equations (10)-(11) below:

$${a}_{3} = {F}_{3} {a}_{2} , \qquad Equation ( 10 )$$

$$where {F}_{3} = \frac{{S}_{26} \cdot {F}_{1} + {S}_{16} {S}_{24}}{{F}_{1} {F}_{2} - {S}_{16}^{2}}$$

$${a}_{1} = {F}_{4} {a}_{2} , \qquad Equation ( 11 )$$

$$where {F}_{4} = \frac{{S}_{24} + {S}_{16} {F}_{3}}{{F}_{1}}$$

Consequently, a field at the through port 113 (b₂) is described in terms of a field at the input port 112 (a₂) as shown in Equation (12) below:

$${b}_{2} = ( {S}_{14} {F}_{4} + {S}_{24} + {S}_{34} {F}_{3} ) \cdot {a}_{2} , \qquad Equation ( 12 )$$

Equation (12) above illustrates that that the responses of the two ring resonators appear in the total through output.

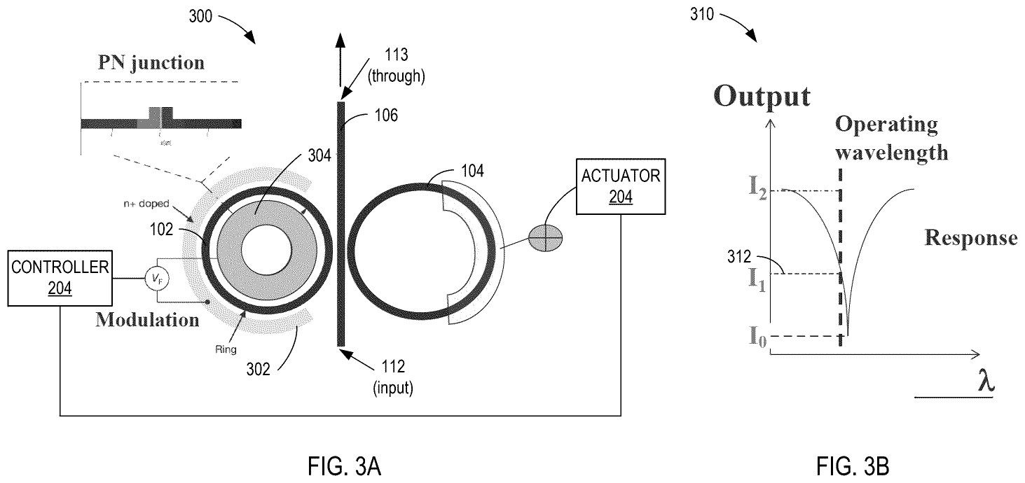

FIG. 3A shows a top-down perspective view of an example multi-ring wave bus structure 300. In some embodiments, the multi-ring wave bus structure 300 is a semiconductor-based implementation of the multi-ring bus structure 101 of FIGS. 1A and/or 2.

As shown, the multi-ring wave bus structure 300 includes semiconductor material on both sides of the first ring resonator 102. The first ring resonator 102 is disposed at least partially inside a ring of an n+ doped semiconductor 302 region. A p+ doped semiconductor 304 region is disposed within the first ring resonator 102.

In some embodiments, the n+ doped semiconductor region 302 implements an N junction and the p+ doped semiconductor region 304 implements a P junction of a semiconductor PN junction. For example, the multi-ring wave bus structure 300 can include a PN junction implemented at least in part by the semiconductor regions 302, 304. In some embodiments, the PN junction can be used to control optical modulation.

In some embodiments, the n+ doped semiconductor 302 region is a group IV intrinsic semiconductor doped with group V elements. Example group IV intrinsic semiconductors include silicon and germanium. Example group V elements include arsenic, antimony, and phosphorous.

In some embodiments, the p+ doped semiconductor 304 region is a group IV intrinsic semiconductor doped with group III elements. Example group IV intrinsic semiconductors include silicon and germanium. Example group III elements include boron and indium.

In some embodiments, the controller 204 can determine to change a property of the first ring resonator 102 to change a property of the first ring resonator 102. For example, the controller 204 can change a modulation of the light propagating through the waveguide bus 106 by controlling the actuator 206 to increase a temperature or decrease a temperature of at least a portion (e.g., a ring portion) of the second ring resonator 104. In another example, the controller 204 can change a modulation of the light propagating through the waveguide bus 106 by controlling the actuator 206 to increase or decrease a voltage across at least a portion (e.g., a ring portion) of the second ring resonator 104. In response to the controller 204 controlling (e.g., changing) the temperature and/or the voltage of at least the portion of the second ring resonator 104, the controller 204 can control (e.g., change) an effective refractive index, a Q-factor, a coupling strength, a spectral response, and/or a spectral range associated with the first ring resonator 102.

FIG. 3B shows a graph 310 representing the light intensity output of the through port 113 of the waveguide bus 106. As shown, the graph 310 has an x-axis representing operating wavelength and a y-axis representing light intensity output.

The dashed lines 312 represent the operating wavelength of light during operation of the multi-ring wave bus structure 300. A minimum light intensity (I₀) is the minimum light energy that passes through the waveguide bus 106 at a specific wavelength. An output intensity (I₁) is the signal intensity measured at the operating wavelength through port 113, while a maximum output intensity (I₂) refers to the maximum signal intensity measured at the through port 113 at another wavelength.

FIG. 4A shows a first example elliptical multi-ring bus structure 400 that includes a first and second elliptical ring resonator 402, 404 and the waveguide bus 106 of FIG. 1A between them. In some embodiments, the first elliptical multi-ring bus structure 400 is at least a partial example implementation of the optical circuit 100 of FIG. 1A. In this example, the elliptical ring resonators 402, 404 are each optically coupled to the waveguide bus 106 but not to each other. For example, the first elliptical ring resonator 402 is not optically coupled to the second elliptical ring resonator 404.

FIG. 4B shows a second example elliptical multi-ring bus structure 410 that includes the first and second elliptical ring resonators 402, 404 of FIG. 4A, the waveguide bus 106 of FIG. 1A between them, and the first waveguide 108 of FIG. 1A optically coupled to the first ring resonator 102. In some embodiments, the second elliptical multi-ring bus structure 410 is at least a partial example implementation of the optical circuit 100 of FIG. 1A.

In this example, the elliptical ring resonators 402, 404 are each optically coupled to the waveguide bus 106 but not to each other. In this example, the first waveguide 108 is optically coupled to the first elliptical ring resonator 402 but not to the second elliptical ring resonator 404.

FIG. 4C shows a third example elliptical multi-ring bus structure 420 that includes the first and second elliptical ring resonator 402, 404 of FIGS. 4A and 4B, the waveguide bus 106 of FIG. 1A, the first waveguide 108 of FIG. 1A, and the second waveguide 110 of FIG. 1A. In this example, the elliptical ring resonators 402, 404 are each optically coupled to the waveguide bus 106 but not to each other. In some embodiments, the third elliptical multi-ring bus structure 420 is at least a partial example implementation of the optical circuit 100 of FIG. 1A.

In this example, the first waveguide 108 is optically coupled to the first elliptical ring resonator 402 but not to the second elliptical ring resonator 404. The second waveguide 110 is optically coupled to the second elliptical ring resonator 404 but not to the first elliptical ring resonator 402.

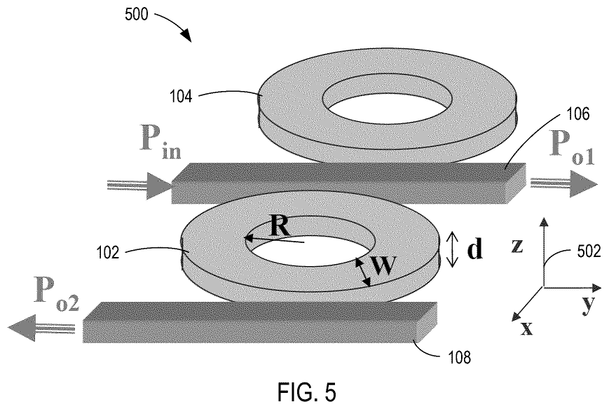

FIG. 5 shows a perspective view of an example implementation of the multi-ring bus structure 101 of FIG. 1A in which the ring resonators 102, 104 are co-planar. For example, the multi-ring bus structure 101 of FIG. 1A can be implemented by a co-planar multi-ring bus structure 500 shown in FIG. 5, where the components of the co-planar multi-ring bus structure 500 are on an X-Y plane of a coordinate system 502.

The ring resonators 102, 104 shown in FIG. 5 can have dimensions in μm and can be quantified with respect to the coordinate system 502. Variables of the ring resonators 102, 104 include a radius (R), a width (w), and a thickness (d).

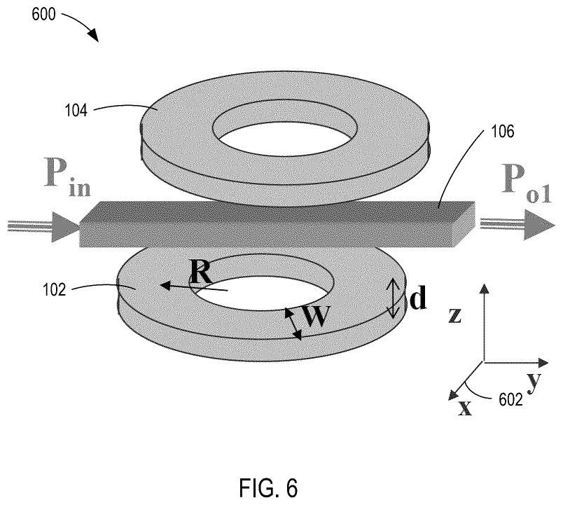

In FIG. 5, the first and second ring resonators 102, 104 are co-planar to each other. Alternatively, the first and second ring resonators 102, 104 may not be co-planar to each other. For example, the first and second ring resonators 102, 104 may be stacked vertically with respect to each other and separated by the waveguide bus 106, as shown by the vertical multi-ring bus structure 600 in FIG. 6.

FIG. 6 shows a perspective view of a vertical multi-ring bus structure 600 including the first and second ring resonators 102, 104 and the waveguide bus 106 of FIG. 1A. The position of the vertical multi-ring bus structure 600 is described with respect to a coordinate system 602. The first ring resonator 102 is on a first XY-plane in proximity to the second ring resonator 104. The waveguide bus 106 is on a second XY-plane above and parallel to the first XY-plane. The second ring resonator 104 is on a third XY-plane above and parallel to the first and second XY-planes. The first, second, and third XY-planes are all parallel to each other and separated from each other along the Z-axis of the coordinate system 602. The first XY-plane is below the second XY-plane, which is below the third XY-plane.

The ring resonators 102, 104 shown in FIG. 6 can have dimensions in μm and can be quantified with respect to the coordinate system 602. Variables of the ring resonators 102, 104 include a radius (R), a width (w), and a thickness (d).

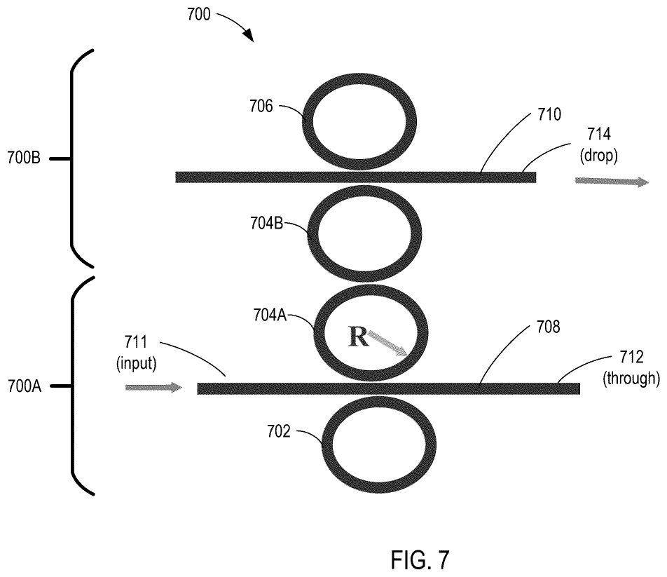

FIG. 7 shows an example multi-ring bus structure 700 that includes a first waveguide bus structure 700A and a second waveguide bus structure 700B. The multi-ring bus structure 700 includes at least four ring resonators 702, 704A, 704B, 706. A first ring resonator 702 is in proximity to, but separated from, a second ring resonator 704A. A third ring resonator 704B is in proximity to, but separated from, the second ring resonator 704A. The third ring resonator 704B is in proximity to, but separated from, a fourth ring resonator 706.

As shown in FIG. 7, the first ring resonator 702 is separated from the second ring resonator 704A by a first waveguide bus 708. Additionally, the third ring resonator 704B is separated from the fourth ring resonator 706 by a second waveguide bus 710. The first waveguide bus structure 700A includes the first and second ring resonators, 702, 704A and the first waveguide bus 708. The first waveguide bus structure 700A includes the third and fourth ring resonators, 704B, 710 and the second waveguide bus 710.

As shown in FIG. 7, the first ring resonator 702, which is on a first side of the first waveguide bus 708, is coupled (e.g., optically coupled) to the first waveguide bus 708 but not coupled (e.g., optically coupled) to the second ring resonator 704A. The second ring resonator 704A and the third ring resonator 704B, which are in a middle section of the multi-ring bus structure 700, are optically coupled. The fourth ring resonator 706, which is on a second side of the second waveguide bus 710, is coupled to the second waveguide bus 710 but not coupled to the third ring resonator 704B. The first side is below the middle section and the second side is above the middle section.

As shown in FIG. 7, signal propagates through the first waveguide bus 708 from an input port 711 and through an output port 712. The first waveguide bus 708 is optically coupled to the second ring resonator 704A, signal transfers from the first waveguide bus 708 to the second ring resonator 704A. The second ring resonator 704A and the third ring resonator 704B are optically coupled, so signal transfers from the second ring resonator 704A to the third ring resonator 704B. The third ring resonator 704B and the second waveguide bus 710 are optically coupled, so signal transfers from the third ring resonator 704B to the second waveguide bus 710. The signal propagating through the second waveguide bus 710 exits through a drop port 714.

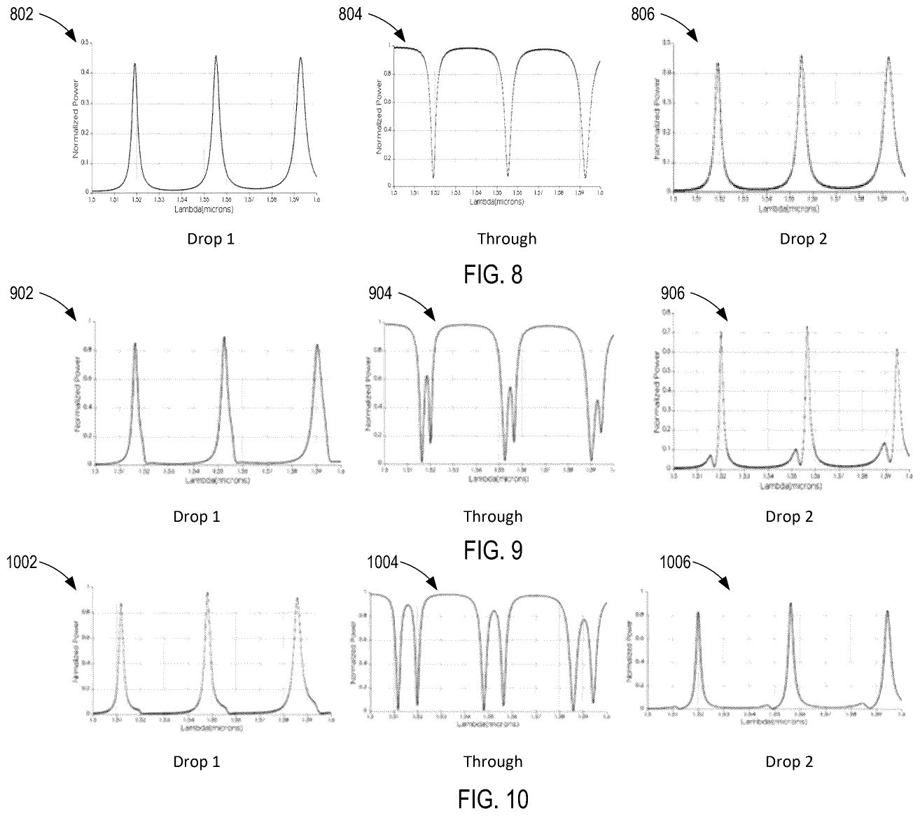

FIGS. 8-10 are plots 802, 804, 806, 902, 904, 906, 1002, 1004, 1006 showing the normalized power output of the multi-ring bus structure 101 of FIG. 1A. The normalized power output for three ports in the multi-ring bus structure 101 include a through port 113 found on the waveguide bus 106, a first drop port 114 found on the first waveguide 108 (drop 2), and a second drop port 116 found on the second waveguide 110 (drop 1).

FIG. 8 shows the normalized output of the three ports in the multi-ring bus structure 101 when the refractive indices and temperatures of the first and second ring resonators 102, 104 are equal. Because the first and second ring resonators 102, 104 have equal refractive indices, they resonate at the same wavelengths.

A first plot 802 showing the normalized power signal of the second drop port 116 of the second waveguide 110 shows a signal peak pattern with symmetrical peaks. A second plot 804 showing the normalized power intensity of the through port 113 of the waveguide bus 106 also shows a signal peak pattern with symmetrical peaks. Signal from the input port 112 of the waveguide bus 106 transfers to the first and second ring resonators 102, 104, illustrated by the local minima in plot 804.

A third plot 806 showing the normalized power intensity of the first drop port 114 of the first waveguide 108 shows a signal peak pattern similar to the signal peak pattern of plot 802. The local maxima of plots 802 and 804 represent the signal transferred from the second and first ring resonators 104, 102, respectively, exiting the coupled waveguides 108, 110 at the drop ports 114, 116. The similarity of the signal peak pattern of plots 802 and 806 are a consequence of the ring resonators 102, 104 being in resonance.

Alternatively, FIG. 9 shows the normalized output at the three ports when the refractive indices of the first and second ring resonators 102, 104 differ by, for example, 0.007 when the temperature difference between the two rings is 36.8 Kelvin (K). A first, second, and third plot 902, 904, 904 show the normalized power intensity of the second drop port 116, through port 113, and first drop port 114, respectively. The signal peak pattern of plots 902 and 906 differ as the ring resonators are no longer in resonance and exhibit different signal transmission behaviors. The plot 904 of the power signal of the through port 113 has bimodal peaks at the local maxima due to the different resonating frequencies of the first and second ring resonators 102, 104. Equation (12) above illustrates that the responses of the first and second ring resonators 102, 104 appear in the total through output at the through port 113.

FIG. 10 shows the normalized output at the three ports when the refractive indices of the first and second ring resonators 102, 104 differ by, for example, 0.016 when the temperature difference between the two rings is 84.21 K. A first, second, and third plot 1002, 1004, 1004 show the normalized power intensity of the second drop port 116, through port 113, and first drop port 114, respectively. The signal peak pattern of plots 1002 and 1006 differ as the ring resonators are no longer in resonance and exhibit different signal transmission behaviors. The plot 1004 of the power signal of the through port 113 has bimodal peaks at the local maxima due to the different resonating frequencies of the first and second ring resonators 102, 104.

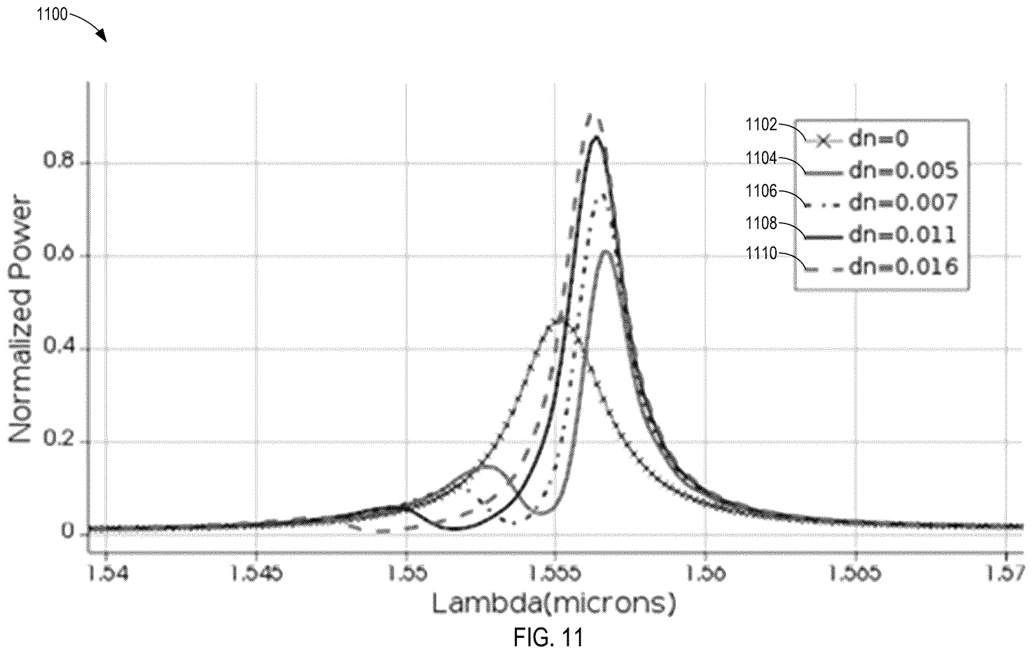

FIG. 11 shows the normalized power output of the first drop port 114 as the refractive index of the second ring resonator 104 changes in a graph 1100. The power output is measured at five refractive index conditions represented by respective plots 1102, 1104, 1106, 1108, 1110. The plots graph 1100 has an x-axis representing light wavelength measured in microns and a y-axis representing normalized power.

When the refractive index of the first and second ring resonators 102, 104 are equal (plot 1102), the normalized output power forms a symmetric peak with a maximum at 1.555 μm. When the refractive index of the second ring resonator 104 is lower than the first ring resonator 102 by 0.005 (plot 1104), the normalized power output of the first drop port 114 shifts right and becomes asymmetric with two local maxima. The formation of two local maxima is a consequence of the first and second ring resonators 102, 104 being out of resonance when the refractive indices of the rings differ. When the refractive index of the second ring resonator 104 is lower than the first ring resonator 102 by 0.007 (plot 1106), the normalized power output of the first drop port 114 shifts left with a similar bimodal asymmetry to plot 1104. The height difference of a first and second local maximum in plot 1104 increases relative to the height of a first and second local maxima in plot 1106. When the refractive index of the second ring resonator 104 is lower than the first ring resonator 102 by 0.011 (plot 1108) and by 0.016 (plot 1110), the power intensity peaks continue to shift left and a height difference between a first and second local maximum continues to increase.

Accordingly, these five refractive index conditions represented by the plots 1102, 1104, 1106, 1108, 1110 of FIG. 11 illustrate how differences in refractive index between the first and second ring 102, 104 affect power output. Consequently, the widening of the local minima and maxima as well as the appearance of bimodal peaks illustrates a reduction in optical filtering quality and a control of its quality factor.

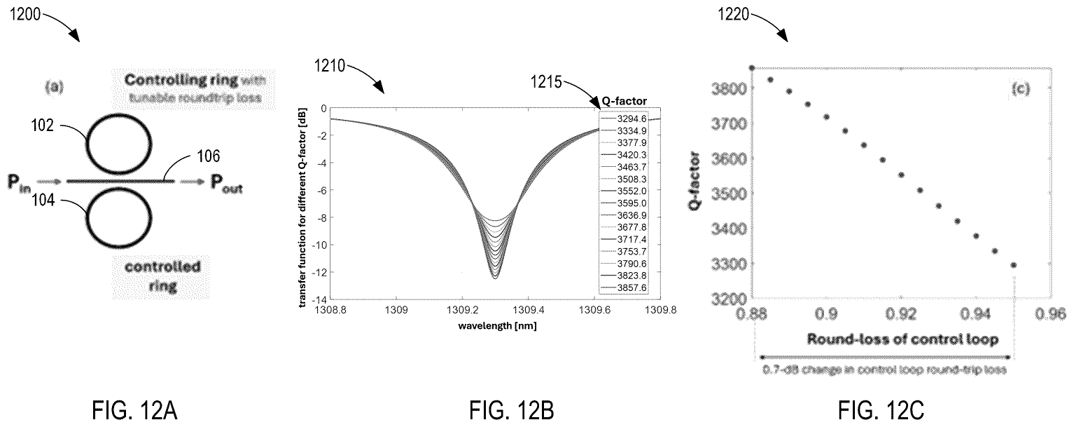

FIG. 12A shows an example multi-ring bus structure 1200 used in the experiments described in connection with FIGS. 12B and 12C. The multi-ring bus structure 1200 includes the ring resonators 102, 104 and the waveguide bus 106 of FIG. 1A.

FIGS. 12B-12C show plots 1210, 1220 illustrating how changing the roundtrip loss ani of the second ring resonator 104 controls the Q-factor of the first ring resonator 102.

FIG. 12B shows a plot 1210 of the transfer function of different Q-factors in the first ring resonator 102 with respect to wavelength. Each curve in the plot 1210 represents a transfer function of the first ring resonator 102 when the Q-factor of the second ring resonator 104 is changed. The Q-factor value for each transfer function curve is indicated by a key 1215 on the right sight of the plot 1210. The plot 1210 has an x-axis representing light wavelength measured in nanometers (nm) and a y-axis representing the transfer function measured in decibels (dB).

FIG. 12C shows a plot 1220 illustrating the decrease in the Q-factor of the first ring resonator 102 as the roundtrip loss of the second ring resonator 104 increases. Each point representing the round-trip loss of the second ring resonator 104 in the plot 1220 corresponds to a transfer function in the plot 1210 depicted in FIG. 12B. The plot 1220 has an x-axis representing round-loss of control loop and a y-axis representing the Q-factor.

The plots 1210, 1220 shown in FIGS. 12B-12C illustrate how the behavior of the first ring resonator 102 is influenced by changing the optical properties of the second ring resonator 104. The plot 1220 in FIG. 12C illustrates how increasing the round-trip loss of the second ring resonator 104 decreases the Q-factor of the second ring resonator 104. This decrease in the Q-factor corresponds to a decrease in performance of the second ring resonator 104. The plot 1210 in FIG. 12B illustrates the influence of an increasing Q-factor in the second ring resonator 104 on the behavior of the first ring resonator 102. By increasing the Q-factor of the second ring resonator 104, the amplitude of the transfer function of the first ring resonator 102 increases.

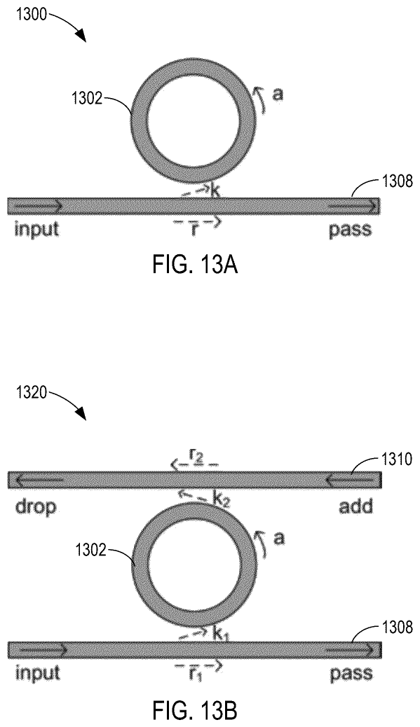

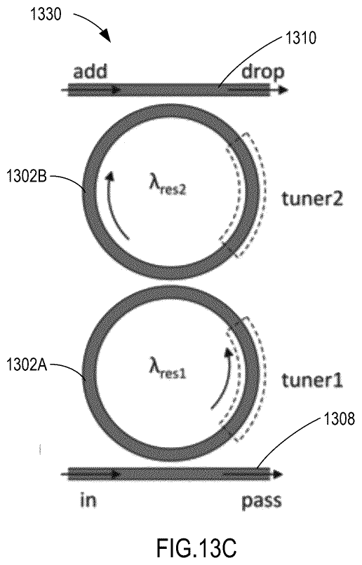

FIG. 13A shows an all-pass filter 1300 including a ring resonator 1302 and a first waveguide bus 1308. The ring resonator 1302 is optically coupled with the first waveguide bus 1308.

FIG. 13B shows an add-drop ring resonator 1320 including the ring resonator 1302 and the first waveguide bus 1308 of FIG. 13A and a second waveguide bus 1310. The first and second waveguide buses 1308, 1310 are on opposite sides of the ring resonator 1302. The ring resonator 1302 is optically coupled with both the first and second waveguide buses 1308, 1310.

FIG. 13C shows a double ring resonator 1330, including a first ring resonator 1302A, a second ring resonator 1302B, the first waveguide bus 1308 of FIG. 13A, and a second waveguide bus 1310. The first and second ring resonators 1302A, 1302B are next to each other at the interior of the double ring resonator 1330, with the first waveguide bus 1308 on one side of the first ring resonator 1302A and the second waveguide bus 1310 on one side of the second ring resonator 1302B. The first ring resonator 1302A and the second ring resonator 1302B do not share an optical bus. A change in a property of the second ring resonator 1302B does not change a property of the first ring resonator 1302A or vice versa.

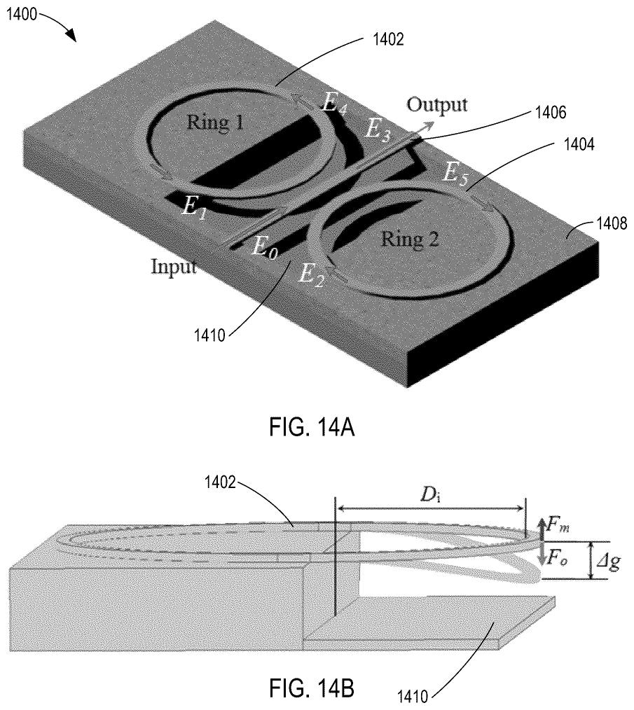

FIG. 14A shows an opto-mechanical ring resonator 1400 including a first ring resonator 1402, a second ring resonator 1404, and a waveguide bus 1406. As shown in FIG. 14A, the waveguide bus 1406 is positioned between the first and second ring resonators 1402, 1404. The first and second ring resonators 1402, 1404 are optically coupled to the waveguide bus 1406. The first and second ring resonators 1402, 1404 and the waveguide bus 1406 are disposed on a substrate 1408 over a recession 1410 in the substrate 1408. A linear segment of the waveguide bus 1406 hands over recession 1410. The arcs of the first and second ring resonators 1402, 1404 hang over the recession 1410. A change in a property of the second ring resonator 1404 does not change a property of the first ring resonator 1402 or vice versa.

FIG. 14B shows a perspective view of the first ring resonator 1402 hanging over the recession 1410 while the opto-mechanical ring resonator 1400 is operating. The arc of the first ring resonator 1402 physically deforms into the recession 1410 a distance Δg when a current is run through the waveguide bus 1406. The arc of the first ring resonator 1402 does not change in response to a change in the second ring resonator 1404.

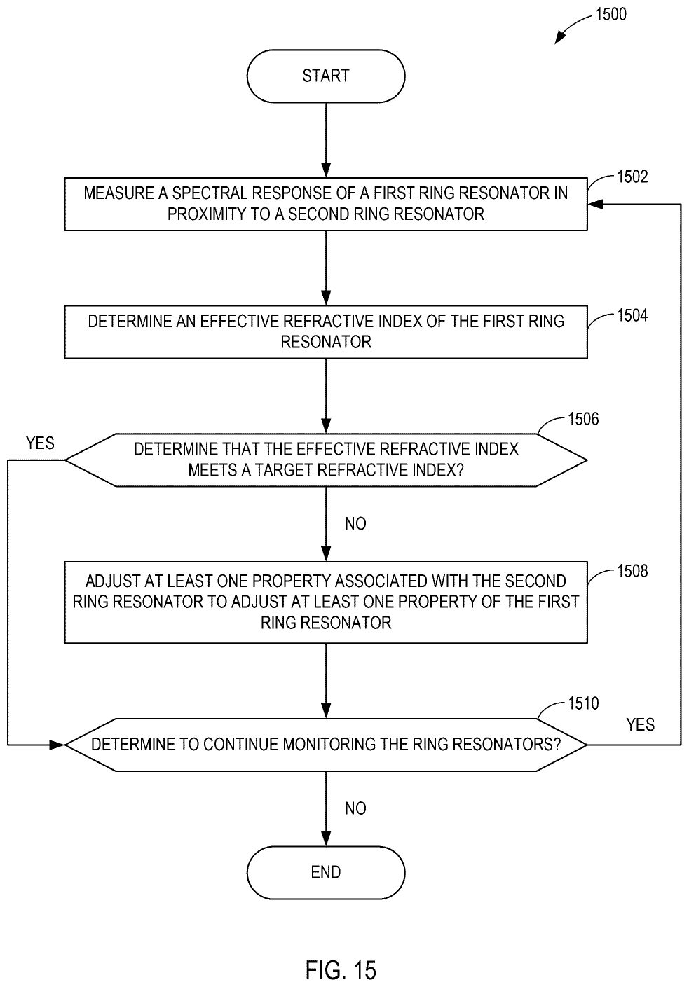

FIG. 15 is a flowchart 1500 representative of example processes to be performed and/or example machine-readable instructions that may be executed by processor circuitry to implement the controller 204 of FIGS. 2 and/or 3. Additionally or alternatively, block(s) of one(s) of the flowchart 1500 may be representative of state(s) of one or more hardware-implemented state machines, algorithm(s) that may be implemented by hardware alone such as an ASIC, etc., and/or any combination(s) thereof.

The flowchart 1500 begins at block 1502, at which the controller 204 may measure a spectral response of a first ring resonator in proximity to a second ring resonator. For example, the controller 204 may measure, using the sensor 202 of FIG. 2, a spectral response of the first ring resonator 102.

At block 1504, the controller 204 may determine an effective refractive index of the first ring resonator. For example, the controller 204 may determine, using the spectral response, an effective refractive index of 1.35. The effective refractive index of 1.35 can represent how light propagates within the first ring resonator 102.

At block 1506, the controller 204 may determine whether the effective refractive index meets a target refractive index. For example, the controller 204 may determine that the measured effective refractive index of 1.35 falls below a target refractive index of 1.50. The target refractive index can be a threshold, such as a target refractive index threshold. In such an example, the controller 204 may determine that the measured effective refractive index of 1.35 does not meet the target refractive index of 1.50 because 1.35 is less than 1.50. In another example, the controller 204 may determine that a measured effective refractive index of 1.60 meets the target refractive index of 1.50 because 1.60 is greater than 1.50.

If, at block 1506, the controller 204 determines that the effective refractive index meets a target refractive index, control proceeds to block 1510. Otherwise, control proceeds to block 1508. At block 1508, the controller 204 may adjust at least one property associated with the second ring resonator to adjust at least one property of the first ring resonator. For example, the controller 204 can change, using the effective refractive index, at least one of (i) a temperature of the second ring resonator 104 and/or (ii) a voltage applied across the second ring resonator 104 to adjust a property of the first ring resonator 102, such as the spectral response of the first ring resonator 102. After adjusting the at least one property at block 1508, control proceeds to block 1510.

At block 1510, the controller 204 may determine whether to continue monitoring the ring resonators. For example, the controller 204 may determine to continue measuring the spectral response of the first ring resonator 102 to monitor performance of the multi-ring bus structure 101 of FIG. 1A and/or, more generally, the optical circuit 100 of FIG. 1A.

If, at block 1510, the controller 204 determines to continue monitoring the ring resonators, control returns to block 1502. Otherwise, the example flowchart 1500 of FIG. 15 concludes.

Techniques operating according to the principles described herein may be implemented in any suitable manner.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

1. A substrate, comprising:
a first ring resonator;
a second ring resonator proximate to the first ring resonator and configured to control at least one optical property of the first ring resonator; and
a waveguide bus disposed between the first ring resonator and the second ring resonator.

2. The substrate of claim 1, wherein at least one of the first ring resonator or the second ring resonator is elliptically shaped.

3. The substrate of claim 2, wherein at least one of the first ring resonator or the second ring resonator is circularly shaped.

4. The substrate of claim 1, wherein the first ring resonator and the second ring resonator are each optically coupled to the waveguide bus.

5. The substrate of claim 4, wherein the first ring resonator is not optically coupled to the second ring resonator.

6. The substrate of claim 1, wherein the first ring resonator and the second ring resonator respectively comprise at least one of silicon, gallium arsenide, gallium nitride, gallium oxide, silicon nitride, or lithium niobate.

7. The substrate of claim 1, wherein the waveguide bus comprises at least one of silicon, gallium arsenide, gallium nitride, gallium oxide, silicon nitride, or lithium niobate.

8. The substrate of claim 1, wherein the substrate comprises at least one of silicon, silicon dioxide, indium phosphide, gallium arsenide, or gallium nitride.

9. An optical circuit comprising:
an input port configured to receive an optical signal;
a substrate coupled to the input port and comprising:
a first ring resonator;
a second ring resonator proximate to the first ring resonator and configured to control at least one optical property of the first ring resonator; and
a waveguide bus disposed between the first ring resonator and the second ring resonator;
an actuator coupled to the second ring resonator;
a sensor configured to measure a spectral response of the first ring resonator;
a controller configured to control, using the spectral response, the actuator to change at least one of (i) a temperature of the second ring resonator and/or (ii) a voltage applied across the second ring resonator to cause a change in the at least one optical property of the first ring resonator; and
an output port configured to output the optical signal.

10. The optical circuit of claim 9, wherein at least one of the first ring resonator or the second ring resonator is elliptically shaped.

11. The optical circuit of claim 10, wherein at least one of the first ring resonator or the second ring resonator is circularly shaped.

12. The optical circuit of claim 9, wherein the first ring resonator and the second ring resonator are each optically coupled to the waveguide bus, and the first ring resonator is not optically coupled to the second ring resonator.

13. The optical circuit of claim 9, wherein the second ring resonator is configured to control the at least one optical property of the first ring resonator in response to a change of (i) a temperature of the second ring resonator and/or (ii) a voltage applied across the second ring resonator.

14. The optical circuit of claim 9, wherein at least one of the first ring resonator or the second ring resonator respectively comprise at least one of silicon, gallium arsenide, gallium nitride, gallium oxide, silicon nitride, or lithium niobate.

15. The optical circuit of claim 9, wherein the waveguide bus comprises at least one of silicon, gallium arsenide, gallium nitride, gallium oxide, silicon nitride, or lithium niobate.

16. The optical circuit of claim 10, wherein an optical transceiver comprises the optical circuit.

17. A method for adjusting at least one optical property associated with an optical circuit, the method comprising:
measuring, using at least one sensor, a spectral response of a first ring resonator disposed in proximity to a second ring resonator;
determining, using a controller and the spectral response, an optical property of the first ring resonator; and
adjusting, using the controller and the optical property, a temperature of the second ring resonator and/or a voltage applied across the second ring resonator to adjust the spectral response of the first ring resonator.

18. The method of claim 17, wherein the spectral response comprises at least one of a first value indicative of a power distribution, a second value indicative of a wave function, a third value indicative of an intensity spectrum, a fourth value indicative of a phase shift, a fifth value indicative of a mode number, or a sixth value indicative of an output optical power.

19. The method of claim 17, further comprising:
determining, using the controller and the spectral response, a quality factor of the first ring resonator, and wherein:
adjusting the temperature and/or the voltage comprises adjusting, using the controller and the quality factor, the temperature and/or the voltage.

20. The method of claim 17, wherein adjusting the temperature and/or the voltage comprises controlling, using the controller, at least one actuator to adjust the temperature and/or the voltage.
